(19) United States
(12) Patent Application Publication
(10) Pub. No.: US 2007/0261114 A1
(43) Pub. Date: Nov. 8, 2007

(54) METHOD AND SYSTEM FOR SECURE SHARING OF PERSONAL INFORMATION

(76) Inventor: Michael Pomerantsev, San Jose, CA (US)

Correspondence Address: SCHWEGMAN, LUNDBERG & WOESSNER, P.A., P.O. BOX 2938, MINNEAPOLIS, MN, 55402, US

(21) Appl. No.: 11/741,058

(22) Filed: Apr. 27, 2007

Related U.S. Application Data
(60) Provisional application No. 60/796,577, filed on May 1, 2006.

(51) Int. Cl. G06F 15/16

(52) U.S. Cl. 726/12

(57) ABSTRACT

A method and a system for secure sharing of personal information are provided. The system may include a communications module to receive a request for personal information of a user, a detector to determine that the request includes a proxy identification key, a matching module to determine that the proxy identification key is associated with the user, a data retrieval module to obtain the requested personal information of the user; and a delivery module to deliver the obtained personal information of the user to an originator of the request. The personal information may be associated with a permanent identification information of the user. The proxy identification key may be viewed as a substitute for the permanent identification information of the user. The proxy identification key may provide additional security by imposing certain restrictions such as the amount of data sharing.

### RELATED APPLICATIONS

This application claims the benefit of U.S. Provisional Application No. 60/796,577, filed on May 1, 2006, under 35 U.S.C. §119(e), which is hereby incorporated by reference.

### TECHNICAL FIELD

This application relates to a method and system for secure sharing of personal information.

### BACKGROUND

Imagine that you entered a website that automatically sets your password to be the last four characters of your login name and does not let you change it. Furthermore, you are required to disclose your login name to hundreds of strangers. Would you consider your access secure? Suppose also, that anybody who knows your name and password would have a full access to all your personal information and the authority to sign up for credit cards in your name. Would you feel secure if your password was nothing but the last four characters of your widely disclosed login name?

It would seem that trusting the security of such a website would be a pure madness. Nobody in his right mind would subscribe to such terms, would he? Actually, we all do because we are required to. Your access to most of your accounts is controlled by an incredibly insecure analogue of such a password—the last four digits of your Social Security Number (SSN).

Your entire 9-digit SSN is available to numerous strangers. Your SSN is available to medical receptionists who handle your records because many medical insurance providers use your SSN as your member ID. Your SSN may be available to your former college classmates because many two-year colleges use your SSN as the student ID. Your SSN is available to the rental office workers of every apartment complex where you rented years ago. In fact, the inventor's SSN was stolen once from an apartment complex that he left many years prior to the theft. Your SSN is available to every accountant and every credit card clerk you ever contacted. Your SSN is available to everybody who stood in line behind you when you subscribed for your cellular telephone service because they overheard you giving it to the salesperson. And don't forget the thief who stole your wallet years ago . . . .

Thus, utilizing the Social Security Number for the purposes of identity verification is prone to security breach, especially when disclosed to complete strangers numerous times, e.g., for background check purposes.

### BRIEF DESCRIPTION OF DRAWINGS

Embodiments of the present invention are illustrated by way of example and not limitation in the figures of the accompanying drawings, in which like reference numbers indicate similar elements and in which:

FIG. 1 is a diagrammatic representation of a network environment, within which an example embodiment may be implemented;

FIG. 2 is a block diagram of a system for secure sharing of personal information, in accordance with an example embodiment;

FIG. 3 a flow chart of a method for secure sharing of personal information, in accordance with an example embodiment;

FIG. 4 is a flow chart of a method for secure sharing of personal information utilizing a supplemental temporary identification key, in accordance with an example embodiment;

FIG. 5 is a diagrammatic representation of an example data structure to represent a temporary personal identification record generated by a Proxy ID Agency, in accordance with an example embodiment; and

FIG. 6 is a diagrammatic representation of an example machine in the form of a computer system within which a set of instructions, for causing the machine to perform any one or more of the methodologies discussed herein, may be executed.

### DETAILED DESCRIPTION

An example method and system is described to permit users to grant various entities access to their personal information in a reliable and secure manner. In one example embodiment, a system may be implemented to generate for users temporary identification information that can be accepted by various service providers in lieu of a unique permanent identification information, such as the social security number (SSN), the driver's license information, etc. The system may reside at a trusted agency, termed a Proxy ID Agency.

The temporary identification information may be generated for a user in a form of a personal identification key (a Proxy ID). A Proxy ID may be associated, by the system, with the user's personal records in order to permit access to personal records of the user, based on the Proxy ID and without the requirement for obtaining the unique permanent personal identification data from the user, such as the user's SSN.

It will be noted, that while a temporary identification information (e.g., a Proxy ID) may be generated without any restrictions with respect to the time duration for which the Proxy ID remains valid, the term “temporary” is being used to distinguish a Proxy ID from the user's unique permanent identification information, such as a SSN. The term “unique,” as used in the phrase “a unique permanent identification information” is utilized to distinguish, for the purposes of this description, any personal information of a user that may or may not be unique (e.g., the last name or the height of a user) from any personal information of a user that is necessarily unique (e.g., the SSN or a driver's license number of a user). A temporary identification information, including a Proxy ID may also be referred to as a proxy identification key.

The Proxy ID may be generated by the Proxy ID Agency in response to a user's request and a successful authentication of the user. The authentication may be performed based on the user's permanent identification data (e.g., based on the user's SSN), or, in some embodiments, based on other identity verification approaches, such as a mechanism that utilizes a secure login.

A Proxy ID system, in one embodiment, may be configured to include means for obtaining various types of personal information for users, such as credit history, medical records, state certifications, and other information. For example, where a service provider, e.g., a credit card company, requires access to an applicant's credit history, the applicant may supply the user's Proxy ID to the credit card provider, thus avoiding disclosing the user's SSN. The credit card provider may supply the Proxy ID to the Proxy ID Agency, along with a request for the user's credit history. The Proxy ID Agency may engage the Proxy ID system to verify that the request for the user's credit history is an authorized request, obtain the user's credit history information, and communicate it to the credit card provider.

As described below in greater detail, a user may request that a Proxy ID is generated with various restrictions, according to the options offered by the by the Proxy ID system. For example, a user may request that a Proxy ID is generated such that it can only be used for a specific purpose (e.g., only for the purpose of applying for a loan), that it can only be used by a particular entity (e.g., by an entity associated with a specific tax ID), or that a Proxy ID expires after a predetermined period of time.

In one example embodiment, a Proxy ID may be utilized in conjunction with a supplemental authentication key that may be termed a Proxy PIN. When the Proxy ID system receives a request for a user's personal records accompanied by a Proxy ID and a Proxy PIN, the Proxy ID system may first verify that the Proxy ID matches the Proxy PIN, prior to obtaining the requested personal records of the user.

In yet another embodiment, a Proxy ID may be utilized in conjunction with a unique permanent identification information of a user (e.g., in conjunction with the SSN of a user) in order to provide additional safeguard against identity theft. One basic technique to protect personal information of a user by utilizing a key in conjunction with permanent identification information of a user is described in a U.S. patent application publication No. 2003/0070101A1 (Buscemi). The techniques discussed in Buscemi may be utilized advantageously with a Proxy ID described herein.

In one example embodiment, a user may request a Proxy ID from a Proxy ID Agency and also request that the Proxy ID is associated with the SSN of a user. As mentioned above, a Proxy ID may be configured with various usage restrictions. The user may communicate his SSN, together with the Proxy ID, to a service provider who would then be able to obtain personal information of the user, but only in accordance with the restrictions associated with the Proxy ID. Based on the SSN and the Proxy ID, an appropriate service may verify that the user is the rightful owner of the SSN by determining that the Proxy ID is associated with the SSN. The Proxy ID may also serve to prevent a service provider from obtaining information that would not be authorized by the user.

Subsequent to providing a Proxy ID to a first service provider, the user may request a new Proxy ID from the Proxy ID Agency and provide this new Proxy ID to the next service provider. It will be noted, that various types of unique permanent identification information of a user, other than SSN, such as credit card numbers, passport numbers, etc., may be protected utilizing the method described above.

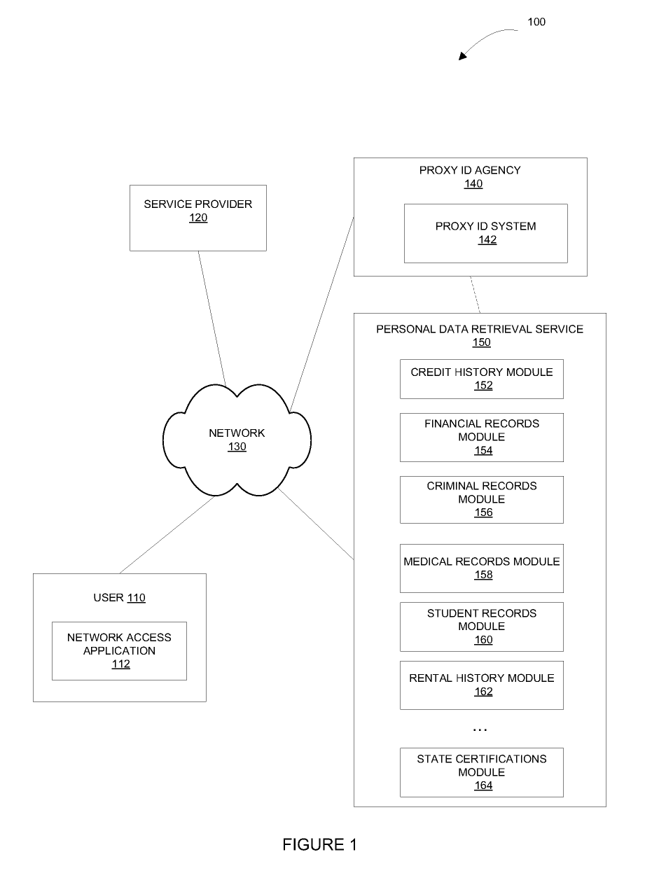

A method and system for secure sharing of personal information may be implemented in the context of a network environment. An example network environment 100 is illustrated in FIG. 1.

As shown in FIG. 1, the network environment 100 may include a user 110 (e.g., an electronic system utilized by a consumer), a service provider 120 (e.g., an electronic system utilized by a vendor), and a Proxy ID Agency 140. The user system 110 may run a network access application 112 and may have access to the Proxy ID Agency 140 via a communications network 130. The communications network 130 may be a public network (e.g., the Internet, a wireless network, a public switched telephone network (PSTN), etc.) or a private network (e.g., LAN, WAN, Intranet, etc.).

The Proxy ID Agency 140 may provide a Proxy ID service 142, which may be configured to provide temporary personal identification keys to a user, that may be utilized to retrieve any personal records of the user that typically require the user to divulge his permanent personal data, such as the user's SSN. The Proxy ID service 142 may include a web-based Proxy ID service, a telephone-based Proxy ID service, as well as any other communication service. In an embodiment where the Proxy ID service is a web based service, the user 110 may utilize a web browser in order to access services provided by the Proxy ID Agency 140.

Also shown in FIG. 1, is a personal data retrieval service 150. The personal data retrieval service 150 may be utilized by the Proxy ID Agency 140 to obtain the requested personal records of a user based on a temporary personal identification key. In some embodiments, the Proxy ID Agency 140 may be a third party agency that can provide personal records based, for example, on the user's SSN. In such scenario, the Proxy ID Agency 140 may act as a liaison between a requesting party (e.g., the service provider 120) and the personal data retrieval service 150, such that the service provider 120 only needs to know the user's temporary personal identification key and not the user's SSN. In some embodiments, the personal data retrieval service 150 may be provided, in whole or in part, within the Proxy ID Agency 140. In further embodiments, the personal data retrieval service 150 may coincide with the Proxy ID Agency 140. The personal data retrieval service 150 may include various modules to obtain and/or store various types of personal records of users, such as, for example, a credit history module 152, a financial records module, a criminal records module, a medical records module, a student records module, a rental history module 162, and a state certifications module. The personal data retrieval service 150 may be configured to utilize various approaches for data retrieval known in the art, such as approaches utilized by Experian®, TransUnion®, or Equifax®.

In one example, the user 110 may obtain a temporary personal identification key from the Proxy ID service 142 and provide the temporary personal identification key to the service provider 120. The service provider 120 may then be able to, e.g., verify the credit-worthiness of the user 110 by submitting the temporary personal identification key of the user to the Proxy ID service 142. The Proxy ID service 142 may then obtain the requested personal records of the user and deliver the obtained records to the service provider 120.

In another example, the user 110 may obtain a temporary personal identification key from the Proxy ID service 142 and provide the temporary personal identification key to the service provider 120. Immediately after generating the temporary personal identification key, the Proxy ID service 142 communicates it to the personal data retrieval service 150. The service provider 120 may then be able to, e.g., verify the credit-worthiness of the user 110 by submitting the temporary personal identification key of the user to the personal data retrieval service 150. The personal data retrieval service 150 then may then obtain the requested personal records of the user and deliver the obtained records to the service provider 120. In this example, the existence of the Proxy ID service 142 is hidden from the service provider 120.

In another example embodiment, the user 110 may obtain a temporary personal identification key from the Proxy ID service 142 and provide the temporary personal identification key to the service provider 120. The service provider may then be able to, e.g., verify the credit-worthiness of the user 110 by submitting the temporary personal identification key of the user to the personal data retrieval service 150. Upon receiving the Proxy ID the personal data retrieval service 150 may send the Proxy ID to the Proxy ID service and receive back the permanent identification of the user, as well as the set of associated restrictions. The personal data retrieval service 150 then may then obtain the requested personal records of the user and deliver the obtained records to the service provider 120.

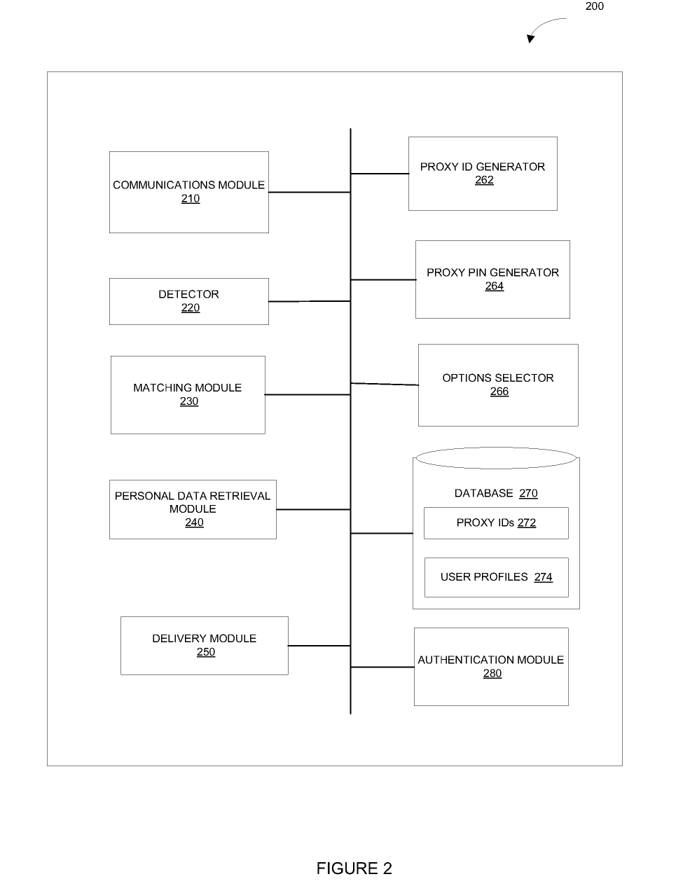

In a different scenario, e.g., where the personal data retrieval service 150 and the Proxy ID Agency 140 are separate entities, the user 110 may be permitted to obtain their personal records from the data retrieval service 150 based on the user's temporary personal identification key and without being required to disclose his SSN to the data retrieval service 150. In this scenario, the personal data retrieval service 150 may be viewed as the service provider 120. It will be noted, that the communications between various entities illustrated in FIG. 1 (e.g., between the user 110 the Proxy ID Agency 140, or the service provider 120 and the Proxy ID Agency 140) may be performed via a number of communications channels, such as via a computer network (e.g., the Internet), via telephone communications, text messages, mail, facsimile, and any other means of communications. An example Proxy ID service, implemented as a Proxy ID system, may be described with reference to FIG. 2.

FIG. 2 is a block diagram of a Proxy ID system 200, in accordance with one example embodiment. FIG. 2 illustrates a plurality of functional modules, some of which may be utilized to process a request for personal data of a user and some of which may be utilized to create a temporary personal identification key for a user.

The system 200 may include a communications module 210, a detector 220, a matching module 230, a personal date retrieval module 240 and a delivery module 250. The communications module may be configured to receive various requests and to forward those requests to appropriate destination modules. The detector 220 may be configured to various information provided with the requests. For example, the detector 220 may be configured to detect a temporary personal identification key provided with a request for personal records of a user.

The matching module 230 may be configured to determine whether a user who is the subject of the request for personal records is a valid owner of the detected temporary personal identification key. The matching module 230 may cooperate with a user profiles database 274 or a Proxy ID database 272 in order to perform the matching operation. In one example embodiment, the user profiles database 274 and a Proxy ID database 272 are maintained as separate databases, because some operations, such as matching a Proxy ID to unique permanent user identification, matching Proxy ID to a list of Proxy IDs, and generating a new Proxy ID may not require access to user records. In some embodiments, however, the user profiles database 272 and a Proxy ID database 274 may be both maintained within a single database 270.

The personal data retrieval module 240 may be configured to retrieve the requested personal records associated with the personal identification key provided with the request. The delivery module 250 may be configured to deliver the obtained personal records to the requesting party.

As mentioned above, the system 200 may include modules to generate temporary identification keys based, for example, on unique permanent identification data of a user. The unique permanent identification data may be, for example, the social security number of the user, the driver's license information of the user, the login name if the user is a subscriber, the passport number of the user, or other personal identification information that does not typically change for the same person. A Proxy ID generator 262, a Proxy PIN generator 264 and an option selector 266 of the system 200 may be utilized to generate a temporary personal identification key for a user based, for example, on the user's social security number. The generated temporary personal identification key may then be associated with the user's permanent identification data and stored in the user profiles database 270. In case the system 200 is configured to generate Proxy IDs without Proxy PINs, the Proxy ID generator 262 may be configured to generate Proxy IDs from a sparse sequence in order to prevent a possibility of random guessing of a Proxy ID by malicious users. Generating Proxy ID/Proxy PIN pairs may provide increased protection against such random guessing.

The system 200 may also allow the user to select a Proxy PIN via communication module 210 after generating a pseudo-random Proxy ID in the Proxy ID generator module 262.

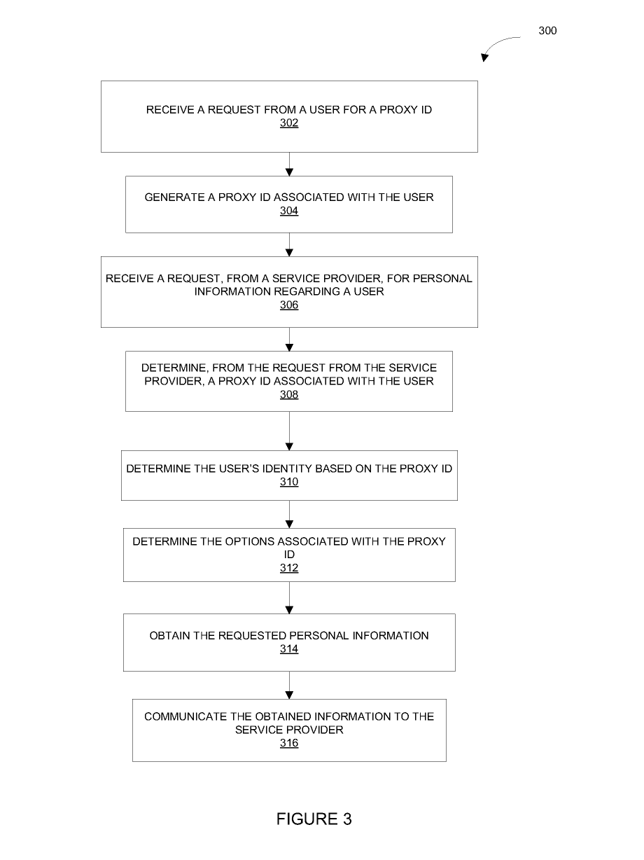

Thus, the system 200 may be configured to generate a temporary identification key based on a user's permanent identification information. However, in some example embodiments, the system 200 may utilize a scenario where a user is authenticated by an authentication module 280 based on previously set up login information, such as the user's login ID and password. Example operations performed by the system 200 may be described with reference to FIG. 3.

FIG. 3 is a flow chart of a method 300 to provide secure sharing of personal information, according to one example embodiment. The method 300 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the system 200 illustrated in FIG. 2. The method 300 may be performed by the various modules discussed above with reference to FIG. 2. Each of these modules may comprise processing logic.

As shown in FIG. 3, at operation 302, the communications module 210 of the system 200 receives a request from a user to generate a new temporary personal identification key for the user. A user's temporary personal identification key may be referred to as a Proxy ID, because a temporary personal identification key may be utilized instead of the user's permanent identification information, such as the user's social security number (SSN). The Proxy ID generator 262 generates the requested Proxy ID at operation 304. The Proxy ID is then communicated to the user. As mentioned above, the user may now use this Proxy ID instead of the user's unique permanent identification information. For example, the user may provide the Proxy ID to his prospective landlord or his prospective employer instead of the user's SSN.

At operation 306, the communications module 210 of the system 200 receives a request from a service provider for personal information regarding the user. For example, the service provider may be a landlord requesting the credit history of a prospective tenant. At operation 308, the detector 220 determines from the request a temporary personal identification key associated with the user (the Proxy ID of the user that may be extracted from the request). At operation 310, the matching module 230 determines the user associated with the Proxy ID (or, in other words, determines the owner of the Proxy ID). This determination may be achieved by interrogating the user profiles database 270. If the matching module 230 determines that the Proxy ID is associated with a user record stored in the user profiles database 270, then the control is passed to the data retrieval module 240.

At operation 312, the detector 220 determines whether there are any restrictions associated with the Proxy ID. As described in further detail below, a Proxy ID may be generated such that it can only be used to retrieve a certain type of information, that it can only be used by a particular service provider, or other types of restrictions. At operation 314, the data retrieval module 240 obtains the requested personal information associated with the user. As mentioned above with reference to FIG. 1, the Proxy ID Agency 140 may maintain personal records of various users. In some embodiments, the Proxy ID Agency 140 may cooperate with one or more personal data retrieval services, such as the personal data retrieval service 150.

Once the data retrieval module 240 is has accessed the requested personal information of the user, at operation 314, the delivery module 250 communicates the obtained information to the service provider at operation 316.

The Proxy ID may be utilized by itself to permit service providers and users obtain the users' personal records. In some embodiments, the Proxy ID may be utilized in conjunction with a secondary or supplemental temporary personal identification key that may be termed a Proxy PIN. Furthermore, as mentioned above, a Proxy ID may be configured with various restrictions, such as restrictions on who may use the Proxy ID to retrieve the user's personal data, how long the Proxy ID is to remain valid, what type of inquiry is allowed, what type of data may be transmitted to the requester, and other restrictions.

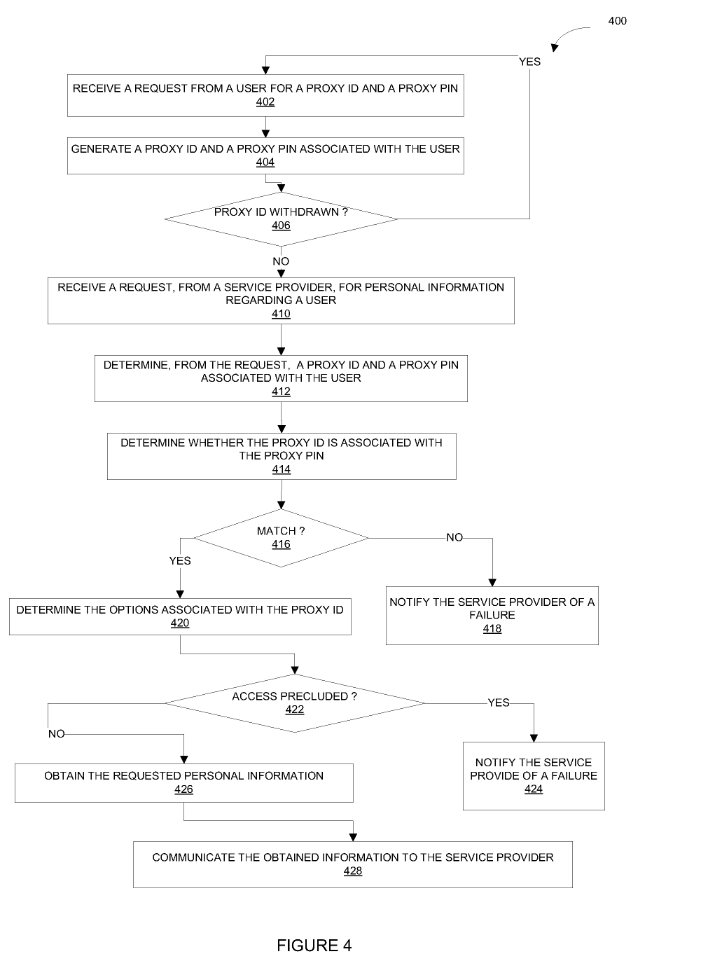

FIG. 4 is a flowchart of a method 400 to obtain personal records of a user utilizing a Proxy ID with a Proxy PIN. The method 400 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the system 200 illustrated in FIG. 2. The method 400 may be performed by the various modules discussed above with reference to FIG. 2. Each of these modules may comprise processing logic.

As shown in FIG. 4, at operation 402, the communications module 210 of the system 200 receives a request from a user to generate a Proxy ID and a Proxy PIN for the user. The Proxy ID generator 262 generates the requested Proxy ID at operation 404. The Proxy ID is then communicated to the user. The user may now use this Proxy ID and Proxy PIN combination instead of the user's unique permanent identification information. In some embodiments, as described in further detail below, the user may be permitted to withdraw the Proxy ID, so that it may no longer be utilized to request any personal information of the user. At operation 406, the detector 220 determines whether the user has requested to withdraw (or to invalidate) the Proxy ID. If it is determined, at operation 406, that the user has not requested to withdraw the Proxy ID, the method 400 continues to operation 410.

At operation 410, the communications module 210 of the system 200 receives a request from a service provider for personal information regarding the user. At operation 412, the detector 220 determines, from the request, a proxy ID and a proxy PIN associated with the user. At operation 414, the matching module matches the Proxy PIN with the Proxy ID to determine whether the Proxy ID is associated with the Proxy PIN. This operation may provide additional assurance that the requester is an authorized holder of the Proxy ID.

If it is determined, at operation 416, that the Proxy ID does not match the Proxy PIN, the service provider is notified of a failure at operation 418. If it was determined, at operation 416, that the Proxy ID matches the Proxy PIN, the control is passed to the detector 220. The detector 220 determines any options or restrictions associated with the Proxy ID at operation 420. As mentioned above, a Proxy ID may be restricted for a particular purpose, for the use by a particular requester, etc. If there are any restrictions associated with the Proxy ID, such as for example the expiration period or the permitted requester, the matching module 230 determines whether the restrictions associated with the request match with the determined restrictions associated with the Proxy ID.

If it is determined, at operation 422, that the determined restrictions associated with the Proxy ID should preclude the requester from obtaining personal records of the user, then the service provider is notified of a failure at operation 424. If it is determined, at operation 422, the requester is not precluded from obtaining personal records of the user, then the data retrieval module 240 obtains the requested personal information at operation 426.

At operation 428, the delivery module 250 communicates the obtained personal information of the user to the service provider. It will be noted, that various restrictions that may be associated with a Proxy ID may include a particular purpose for which the Proxy ID is requested; a list of types of data that should be provided for the Proxy ID; an expiration date or expiration time period; a particular requester, such as a particular vendor associated with a certain tax ID that can be allowed to obtain personal information; as well as other restrictions, such as the number of times that a Proxy ID can be used to obtain the user's personal records.

The delivery module 250 may also modify the user's records by removing all occurrences of the permanent identification or replacing permanent identification with the Proxy ID. For example, SSN of the user may be replaced in the records with the Proxy ID prior to delivering the records to the service provider.

It should be noted, that the Proxy ID Agency may act as a request validation system for a personal data retrieval service. In this case the steps 426 and 428 are replaced by a “go ahead” message sent to the personal data retrieval service, and it is the personal data retrieval service that obtains and communicates the user's personal data to the service provider.

Returning to FIG. 2, the system 200 may include modules responsible for generating a temporary personal identification key (or Proxy ID). For example, the Proxy ID generator 262 may be configured to generate a Proxy ID in response to a request by a user. The Proxy PIN generator 264 may be configured to generate a supplemental authentication key (a Proxy PIN) or to allow the user to select a Proxy PIN. As mentioned above, with reference to FIG. 4, the use of a Proxy PIN may contribute to increased reliability and security of a process of sharing personal records of a user.

The option selector 266 of the system 200 may be configured to permit a user to select various restrictions and associate those restrictions with the Proxy ID. The use of various restrictions was mentioned above with reference to FIG. 3 and will also be described below in some of the examples provided to illustrate the use of some embodiments of the system to share personal records. A Proxy ID and a Proxy PIN, collectively referred to as temporary personal identification data, may be implemented, in one embodiment, as a data structure as described below.

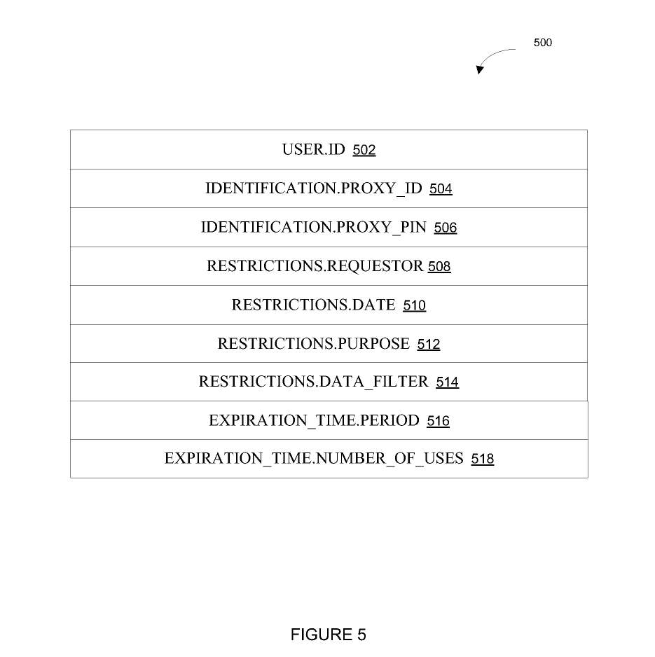

FIG. 5 is a diagrammatic representation of an example data structure 500 to represent a temporary identification record generated by the system 200 of FIG. 2, in accordance with an example embodiment. As shown in FIG. 5, the example data structure 500 comprises fields 502 through 518.

“USER.ID” field 502 may be used to provide a link to the rest of the data associated with the user. The data stored in the “USER.ID” field 502, in one example embodiment, is not transmitted as part of the Proxy ID, except for where the data is being exchanged between the Proxy ID Agency 140 and the personal data retrieval service 150. “IDENTIFICATION.PROXY_ID” field 504 is used to represent the primary temporary identification information associated with the user.

“IDENTIFICATION.PROXY_PIN” field 506 is used to represent a supplemental authentication information assigned to the user by the Proxy ID service. The difference between Proxy ID and Proxy PIN, in one example embodiment, is that Proxy ID alone is sufficient to identify the user, but both Proxy ID and Proxy PIN may be required to grant access to the user's records. Thus, after obtaining the necessary information, the service provider may choose to keep only the Proxy ID of the user in his records, to associate them with the user, and to discard the Proxy PIN. This approach may further enhance security of the personal information of the user.

“RESTRICTIONS.REQUESTOR” field 508 is used to represent one or more entities or a plurality of entities that are permitted to make request utilizing the Proxy ID (e.g., ACME University, any university, or a specific employer and a specific landlord). “RESTRICTIONS.DATE” field 510 is used to indicate a particular date, several dates or a range of dates on which the Proxy ID can be used to retrieve personal records of the user. “RESTRICTIONS.PURPOSE” field 512 is used to indicate a particular purpose or several purposes or a class of purposes, which the Proxy ID can be used (e.g., only for an auto loan application, or any credit application). “RESTRICTION.DATA_FILTER” field 514 is used to limit the type of data available via the Proxy ID request (e.g., a particular type of data may include financial records, student records, medical records, credit history, or a combination of various types of data).

“EXPIRATION.TIME_PERIOD” field 516 is used to indicate the time period after which the Proxy ID expires. In one example embodiment, the expiration period for a Proxy ID may run from a certain event, such as the first inquiry that utilizes the Proxy ID. “EXPIRATION.NUMBER_OF_USES” field 518 is used to indicate the number of uses after which the Proxy ID expires. For example, a Proxy ID may be configured to expire after it has been used once, to decrease the likelihood of unauthorized assess to the user's personal records.

It will be noted, that a temporary identification record, as well as other information utilized by the system 200 of FIG. 2, may be represented utilizing a variety of techniques that may be available to a person skilled in the art.

### Example Usage

Suppose, a user walks into a rental office to apply for an apartment. Now the user needs to disclose the relevant personal information to the prospective landlord. Instead of disclosing the user's SSN, the user may make a telephone call to a Proxy ID Agency. The following dialogue between the Automated Phone System (APS) and a cell phone keypad may ensue:
APS: Welcome to Proxy ID System. Please enter 1 to request a Proxy ID and 2 to make inquiries.
User: 1#
APS: Please enter your SSN.
User: 123456789#
APS: Please enter your first name on the keypad.
User: John#
APS: Please enter your last name on the keypad.
User: Smith#
APS: Please select the acceptable inquiry for your Proxy ID: 1 application for a loan or a credit card, 2 apartment rental or other services, 3 state licensure, 4 non-inquiry ID, 5 job application, 0 for any purpose.
User: 2#
APS: Please enter all the items available through your Proxy: 1 credit history, 2 financial records, 3 criminal records, 4 medical records, 5 student records, 6 rental history, 7 state certifications, 0 for all available records.
User: 136#
APS: Please enter the number of days for your Proxy to be active.
User: 3#
APS: Please enter the Tax ID or Proxy ID of the company authorized to make inquiries, 0 for any company.
User: 0#
APS: Your Proxy ID number is 314159265358979. Your Proxy PIN is 27182818. Thank you for using Proxy ID system. Bye.

Now the user can give the landlord the obtained Proxy ID that will be effective only for 3 more days and will provide access only to the user's credit history, criminal records, and rental records, and nothing more. The landlord cannot use this Proxy ID to apply for a credit card because the Proxy ID has specific purpose “apartment rental or other services.” If the user also wanted to make sure that the landlord could not use his identity to apply for some other services somewhere else, the user could simply enter the apartment's Tax ID at the last step instead of entering a “0.”

Now the user may provide to the landlord both the Proxy ID and the Proxy PIN and the landlord may make the relevant inquiries by calling the Proxy ID Agency:
APS: Welcome to Proxy ID System. Please enter 1 to request a Proxy ID and 2 to make inquiries.
Landlord: 2#
APS: Please enter your Tax ID or Proxy ID. The user may enter 0 if the Proxy ID for the inquiry allows access by any company.
Landlord: 0#
APS: Please enter the Proxy ID for the inquiry.
Landlord: 314159265358979#
APS: Please enter the Proxy PIN for the inquiry.
Landlord: 27182818#
APS: Please choose the delivery option: 1 by fax, 2 by email, 3 by a text message, . . . .
Landlord: 1#
APS: Please enter your fax number.
Landlord: 5555555555#
APS: You will receive credit history, criminal records, and rental records for John Smith within the next 15 min. Thank you for using the Proxy ID System. Bye.

An alternative embodiment does not require the landlord to deal with the Proxy ID Agency. Instead, the landlord applies for the user's credit information directly to the credit reporting agencies, but he identifies the user by the user's Proxy ID or a Proxy ID and a Proxy PIN combination instead of the usual SSN. Most of the scenarios below could be implemented either way—with explicit involvement of the Proxy ID Agency in every transaction or with the Proxy ID Agency working behind the scenes with no service provider involvement. Described below are the details for the explicit involvement only, the other approach could be deduced easily.

Upon receiving an inquiry, the Proxy ID Agency that provides the user with the Proxy ID and Proxy PIN may perform operations as listed below.
1. Verify that the Proxy ID and the Proxy PIN match.
2. Verify that the inquiry is acceptable, e.g., the Proxy ID did not expire and the inquirer is the same as was intended when the Proxy ID was created.
3. Internally match the Proxy ID to your records.
4. If necessary, make the relevant inquiry into data collection agencies such as, for example, Equifax®, Inc. to compile all the requested information.
5. Remove John Smith's SSN from all the records and replace it with the Proxy ID without the Proxy PIN.
6. Deliver the results of the inquiry to the landlord.

The landlord receives the records identified by their Proxy ID. The Proxy PIN may be discarded at this point, because the Proxy ID is sufficient for the user identification. Even if the Proxy PIN is not discarded, nobody can use it for any purpose other than the purpose that was associated with this Proxy ID at the time the Proxy ID was generated, and nobody can use it at all after 3 days.

### Persistent Identification

In some example embodiments, the Proxy ID may be used advantageously not only for retrieving personal information, but also for matching a person with the record or matching two records. For example, the same person may apply for Proxy ID several times, and, as a result, would obtain several different Proxy IDs. A service provider may need to match a user's Proxy ID to a different Proxy ID utilized by the same user in his prior dealings with the same service provider.

Suppose that in the previous scenario the landlord keeps on his computer a list of his most annoying prior tenants that should not be rented to anymore. This list consists of the Proxy IDs they provided when they rented before without the Proxy PINs. After the user applied for the apartment the landlord wants to check whether the user has rented from him before.

The landlord may access the Proxy ID Agency website, choose the Proxy ID Matching page, and enters the first Proxy ID:
Enter new Proxy IDs: 314159265358979

In a separate box the landlord pastes the list of Proxy IDs of his most annoying prior tenants:
Enter prior Proxy IDs: 32384626433832795, 452353602874713527,

The landlord clicks OK and the website displays the following:
Proxy ID 314159265358979 matched Proxy ID 32384626433832795

It will be noted that, for this operation, the landlord didn't have to save the Proxy PINs. Saving only a half of the information that is necessary for the personal info retrieval may further improve security.

Of course, the user interface of Proxy ID matching can vary. For example, Proxy ID Agency could provide a service for saving the list of prior Proxy IDs online in order to avoid copies on the local computers. Saving online may also facilitate Proxy ID matching over non-computer communication means such as phone or text messaging. In addition, matching a single Proxy ID with a list of N Proxy IDs could be done in O(log N) time if Proxy ID Agency stores the list internally in the order of the corresponding USER.ID fields.

### Mutual Mistrust Scenario

The Proxy ID/Proxy PIN pair can be used advantageously for secure and restricted sharing of information under the conditions of mutual mistrust.

Suppose that the user would like to hire a babysitter and would like to get her criminal records and state certification. Suppose the babysitter wants would like to provide the user a Proxy ID that would disclose her records only to the user and to nobody else, so she asks the user for the user's tax ID. If the user does not wish to disclose his Tax ID, the user may instead obtain a Proxy ID from the Proxy ID Agency.

The user may a text message to the Proxy ID Agency, as follows.
Get non-inquiry Proxy ID for John Smith SSN 123456789 for 3 days by anybody.

The user receives two text messages from the Proxy ID Agency.
Proxy ID for 3 days John Smith inquiry is 11235813.
Proxy PIN for 3 days John Smith inquiry is 213455.

The user then discloses to the potential babysitter the Proxy ID, but not the Proxy PIN. For example, the user can forward to the babysitter the 1st text message, but not the 2nd one. Without the Proxy PIN, the Proxy ID cannot be used for information retrieval but can successfully be used by the Proxy ID Agency, in place of the user's tax ID, to determine whether the user is authorized to obtain the babysitter's records based on the babysitter's Proxy ID.

The babysitter then makes the call as follows.
APS: Welcome to Proxy ID System. Please enter 1 to request a Proxy ID and 2 for making inquiries.
Babysitter: 1#
APS: Please enter your SSN.
Babysitter: 987654321#
APS: Please enter your first name on the keypad.
Babysitter: Samantha#
APS: Please enter your last name on the keypad.
Babysitter: Jones#
APS: Please select the acceptable inquiry for your Proxy ID: 1 application for a loan or a credit card, 2 apartment rental or other services, 3 state licensure, 4 non-inquiry ID, 5 job application, 0 for any purpose.
Babysitter: 5#
APS: Please enter all the items available through your Proxy: 1 credit history, 2 financial records, 3 criminal records, 4 medical records, 5 student records, 6 rental history, 7 state certifications, 0 for all available records.
Babysitter: 37#
APS: Please enter the number of days for your Proxy to be active.
User: 3#
APS: Please enter the Tax ID or Proxy ID of the company authorized to make inquiries, 0 for any company.
User: 11235813#
APS: Your Proxy ID number is 1357908642. Your Proxy PIN is 2468097531. Thank you for using the Proxy ID System. Bye.

Now the babysitter can give her Proxy ID and Proxy PIN to the user and the user can request the necessary info. This time the user may access the web-based interface provided by the Proxy ID agency, choose the Information Retrieval page, and enter data as described below.
Enter your Tax ID or Proxy ID: 11235813#
Enter your Proxy PIN: 213455#
Enter the Proxy ID for the inquiry: 1357908642#
Enter the Proxy PIN for the inquiry: 2468097531#
Select delivery method: HTML

After that HTML document with the appropriate record appears in the web browser. Neither the babysitter nor the user disclosed their permanent personal information to each other, such as their respective SSNs. It will be noted also that a variety of communication means can be mixed in the same transaction.

### Delayed Authorization Scenario

A single Proxy ID could be used multiple times, as described below. It allows multiple authorizations for the same Proxy ID, does not require separate connection for each authorization, and allows the owner of the Proxy ID to change his mind about some authorizations.

Suppose a user would like to apply for multiple jobs, but does not wish to contact Proxy ID Agency in each office. The user may send the following request (e.g., via a text message) to the Proxy ID Agency.
Get preliminary Proxy ID for John Smith SSN 123456789.

You receive these two text message from the Proxy ID Agency:
Preliminary Proxy ID for John Smith is 11235813.
Preliminary Proxy PIN for John Smith inquiry is 213455.

The user then may visit multiple offices and request non-inquiry Proxy ID described above from each office. This doesn't require access to the Proxy ID Agency by the user. The user discloses the Preliminary Proxy ID in each office, but does not disclose the Preliminary Proxy PIN.

Each office may then make a request as shown below.
Get non-inquiry Proxy ID for ACME Corporation Tax ID 123456789 for Proxy ID 11235813.

The 1st office will receive and disclose to the user the following.
Proxy ID for 11235813 is 3141326.

The 2nd office will receive and disclose to the user the following.
Proxy ID for 11235813 is 2718.

The 3rd office will receive and disclose to the user the following.
Proxy ID for 11235813 is 124816.

After visiting all offices you he user may decide to authorize the 1st and 2nd ones, but not the 3rd one. The user may then send the following message to the Proxy ID Agency.
Authorize Proxy ID 11235813 for 3141326 and 3141326 for all records Pin 213455.

Now the 1st and 2nd office can make inquiries to Proxy ID 11235813, but not the 3rd one. Similarly, the user may be permitted to customize access for each of the offices.
Authorize Proxy ID 11235813 for 3141326 for medical records and 3141326 for student records Pin 213455.

### Initial Authentication

Notice that in the example use scenarios described above a user had to disclose his SSN to the Proxy ID Agency in order to acquire a Proxy ID. The Proxy ID Agency may be configured to utilize the user's SSN in order to authenticate the user first. Disclosing the user's SSN to the same agency several times is more secure than disclosing it to different strangers the same number of times.

In some example embodiments, the Proxy ID Agency may be configured to substitute the use of SSN for the initial authentication of a user by utilizing a User ID and a password. Thus, a person who wishes to use the Proxy ID Agency may first apply for a User ID with the Proxy ID Agency. This may require the user to disclose his SSN only once, during the initial registration process. The user may be permitted to periodically change the password that was initially assigned to the user by the Proxy ID Agency.

### Example Details of the Protocols

In some embodiments, the system and method for secure sharing of personal information may be implemented utilizing a variety of techniques. Some of the approached are outlined below.
1. Generating Proxy IDs and Proxy PINs could be done by any pseudorandom generator that uses a feedback from a database (DB) of previously used Proxy IDs, in order to avoid duplicates.
2. Distributing the Proxy ID can be done via any secure means of communications. In addition to the example communications means described above, a token card may be utilized. A token card may be configured to act as a provider of a temporary pin. When a user wants to login into the server from a remote computer he enters his user id, password, and a temporary pin from the token display that changes periodically, e.g., every minute. Upon entering the User ID and password, the token card would display the Proxy ID and Proxy PIN. This can be done either by having synchronized Proxy generation algorithms or by telecommunication between the token card and the Proxy ID Agency servers.
3. Restricting the amount and the kind of information available through each Proxy ID, based on various criteria, such as the identity of the requester of personal records, expiration period, etc.
4. Associating the Proxy IDs with the personal records can be done, in one example embodiment, utilizing a relational database, e.g., with the Proxy ID being the primary key for accessing the User ID that identifies the records.
5. The matching of two or more Proxy IDs to determine whether the two or more Proxy IDs are associated with the same user may be implemented, in one example embodiment, as follows. Suppose that a company makes a request to check whether the Proxy ID 314159265358979 matches any Proxy ID from the following list: 32384626433832795, 452353602874713527, 11235813213455. This can be done in linear time by converting each of the Proxy IDs into the corresponding User ID and then comparing the resulting User IDs. The User IDs in each list may be sorted first, and then the matches may be retrieved by merging the two lists. The matching of the User IDs to the Proxy IDs can be done, e.g., by maintaining back references, or by storing Proxy IDs internally by the Proxy ID Agency in the order corresponding to their USER.ID values. In one example embodiment, a list of Proxy IDs may be stored for a service provider at the Proxy ID Agency, e.g., as part of a user's profile for the service provider. This approach may make the comparisons of Proxy IDs more user friendly for the subscribers to the Proxy ID service.

### Transparent Usage

In one example embodiment, the Proxy ID Agency may provide to users Proxy IDs that do not require corresponding Proxy PINs that may be used instead of SSN for the purpose of giving access to the user's personal records. Thus, the Proxy IDs may be utilized as temporary SSNs. The Proxy IDs may be then communicated to the three major credit agencies that would treat the requests based on the Proxy IDs as if they were the original SSNs. An example usage scenario is described below.

Suppose a user just walked into a rental office to apply for an apartment. Now the user needs to disclose the relevant personal information to the landlord. Instead of disclosing the user's SSN, the user makes a telephone call to a Proxy ID Agency. A dialogue between the Automated Phone System (APS) and the cell phone keypad may proceed as outlined below.
APS: Please enter your real SSN.
You: 123456789#
APS: Please enter your first name on the keypad.
You: John#
APS: Please enter your last name on the keypad.
You: Smith#
APS: Please enter all the items available through your temporary SSN: 1 credit history, 2 financial records, 3 criminal records, 4 medical records, 5 student records, 6 rental history, 7 state certifications, 0 for all available records.
You: 136#
APS: Please enter the number of days for your temporary SSN to be active.
You: 3#
APS: Your temporary SSN number is 314-15-9265.

The user may now provide the temporary SSN to the landlord. The temporary SSN is configured to be effective only for 3 more days and will provide access only to the user's credit history, criminal records, and rental records, and nothing else.

A temporary SSN may be made in a 9-digit numeric or 9-character alphanumeric format in order to permit utilizing legacy transaction records that provide a data field for a SSN. For example, the proxy identification key may be in a format of nine characters, possibly separated by dedicated symbols. The dedicated symbols may include, e.g., dashes (as in “123-45-6789”).

A temporary SSN may be entered into such field instead of the actual SSN. An approach similar to the approach utilizing a temporary SSN may be utilized advantageously in other countries that use unique personal identifications for citizens, by providing a temporary identification in a format that matches the format of the unique personal identifications utilized in that particular country.

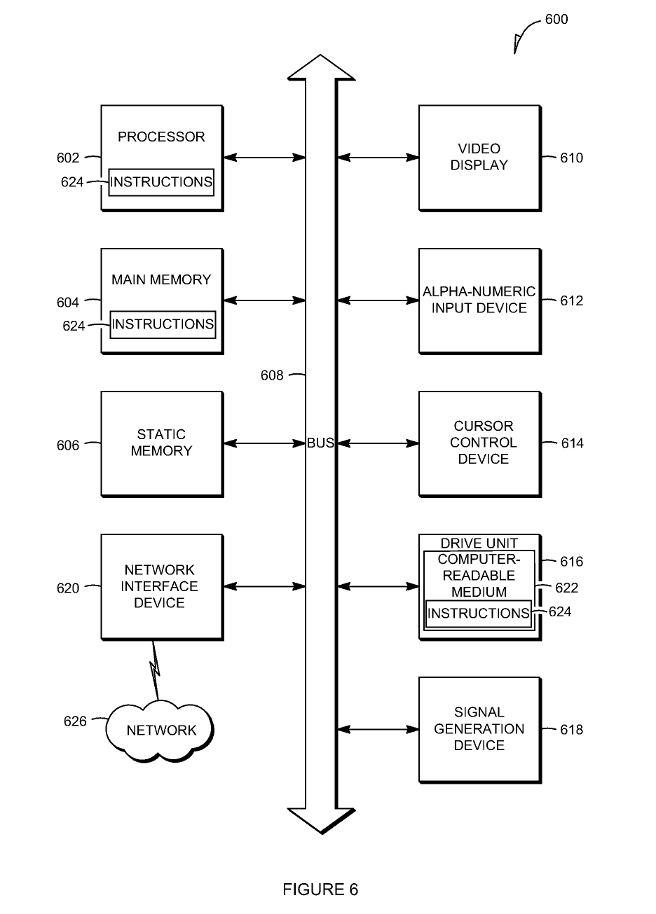

FIG. 6 shows a diagrammatic representation of a machine in the example form of a computer system 600 within which a set of instructions, for causing the machine to perform any one or more of the methodologies discussed herein, may be executed. In alternative embodiments, the machine operates as a stand-alone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processor 602 (e.g., a central processing unit (CPU), a graphics processing unit (GPU) or both), a main memory 604 and a static memory 606, which communicate with each other via a bus 608. The computer system 600 may further include a video display unit 610 (e.g., a liquid crystal display (LCD) or a cathode ray tube (CRT)). The computer system 600 also includes an alpha-numeric input device 612 (e.g., a keyboard), a user interface (UI) navigation device 614 (e.g., a cursor control device), a disk drive unit 616, a signal generation device 618 (e.g., a speaker) and a network interface device 620.

The disk drive unit 616 includes a machine-readable medium 622 on which is stored one or more sets of instructions and data structures (e.g., software 624) embodying or utilized by any one or more of the methodologies or functions described herein. The software 624 may also reside, completely or at least partially, within the main memory 604 and/or within the processor 602 during execution thereof by the computer system 600, the main memory 604 and the processor 602 also constituting machine-readable media.

The software 624 may further be transmitted or received over a network 626 via the network interface device 620 utilizing any one of a number of well-known transfer protocols (e.g., Hyper Text Transfer Protocol (HTTP)).

While the machine-readable medium 622 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of embodiments of the present invention, or that is capable of storing, encoding or carrying data structures utilized by or associated with such a set of instructions. The term “machine-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAMs), read only memory (ROMs), and the like.

The embodiments described herein may be implemented in an operating environment comprising software installed on a computer, in hardware, or in a combination of software and hardware.

Thus, a method and system method and system for secure sharing of personal information have been described. Although embodiments have been described with reference to specific example embodiments, it will be evident that various modifications and changes may be made to these embodiments without departing from the broader spirit and scope of the inventive subject matter. Accordingly, the specification and drawings are to be regarded in an illustrative rather than a restrictive sense.

1. A system comprising:
a communications module to receive a request for personal information of a user, the personal information associated with a permanent identification of the user
a detector to determine that the request includes a proxy identification key, the proxy identification key being a substitute for the permanent identification of the user;
a matching module to determine that the proxy identification key is associated with the user;
a data retrieval module to obtain the requested personal information of the user; and
a delivery module to deliver the obtained personal information of the user to an originator of the request.

2. The system of claim 1, wherein the data retrieval module is to:
determine that the proxy identification key is associated with a specific purpose of inquiry; and
determine that the request is associated with the specific purpose of inquiry.

3. The system of claim 2, wherein the specific purpose of inquiry is a credit application by the user.

4. The system of claim 1, wherein the delivery module is to:
determine that the proxy identification key is associated with a specific type of request; and
determine that the request is of the specific type.

5. The system of claim 1, wherein the delivery module is to:
determine a permitted amount of information associated with the proxy identification key; and
communicate only the permitted amount of the obtained personal information of the user.

6. The system of claim 1, wherein the data retrieval module is to:
determine that the proxy identification key is restricted to one or more vendors; and
determine that the request is associated with the one or more vendors.

7. The system of claim 1, wherein the delivery module is to:
determine that the proxy identification key is associated with one or more permitted dates; and
determine that the request is made on a permitted date from the one or more permitted dates.

8. The system of claim 1, wherein the data retrieval module is to:
determine that the proxy identification key is restricted to a predetermined number of uses; and
determine that the proxy identification key has been used less than the predetermined number prior to the request.

9. The system of claim 1, wherein the proxy identification key is in a format of nine characters.

10. The system of claim 9, wherein the proxy identification key includes one or more dedicated symbols.

11. The system of claim 1, wherein the proxy identification key is in a format customary for user identification in an environment, in which the proxy identification key is being used.

12. The system of claim 1, wherein the detector is to:
detect a supplemental personal authentication key associated with the request; and
determine that the proxy identification key is associated with the supplemental personal authentication key.

13. The system of claim 1, wherein the permanent identification information of the user is the social security number of the user.

14. The system of claim 1, wherein the permanent identification information of the user is the passport number of the user.

15. The system of claim 1, wherein the permanent identification information of the user is the driver's license number of the user.

16. The system of claim 1, wherein the permanent identification information of the user is the Identification Card number of the user.

17. The system of claim 1, wherein the permanent identification information includes the name of the user.

18. A method comprising:
receiving a request for personal information of a user, the personal information associated with permanent identification information of the user;
determining that the request includes a proxy identification key, the proxy identification key being a substitute for the permanent identification information of the user;
determining that the proxy identification key is associated with the user;
obtaining the requested personal information of the user; and
communicating the obtained personal information of the user to an originator of the request.

19. The method of claim 18, wherein the obtaining of the requested personal information of the user comprises:
determining that the proxy identification key is associated with a specific purpose of inquiry; and
determining that the request is associated with the specific purpose of inquiry.

20. The method of claim 19, wherein the specific purpose of inquiry is a credit application.

21. The method of claim 18, wherein the communicating of the obtained personal information of the user comprises:
determining a permitted amount of information associated with the proxy identification key; and
communicating only the permitted amount of the obtained personal information of the user.

22. The method of claim 21, wherein the permitted amount of information includes a credit report of the user.

23. The method of claim 18, wherein the obtaining of the requested personal information of the user comprises:
determining that the proxy identification key is restricted to one or more vendors; and
determining that the request is associated with the one or more vendors.

24. The method of claim 23, wherein the determining that the request is associated with the particular vendor is based on a permanent identification information associated with the vendor.

25. The method of claim 23, wherein the determining that the request is associated with the particular vendor is based on a temporary vendor identification, the temporary vendor identification being a substitute for a permanent identification information associated with the vendor.

26. The method of claim 18, wherein the obtaining of the requested personal information of the user comprises:
determining that the proxy identification key is restricted to one or more dates; and
determining that the request is associated with a date from the one or more dates.

27. The method of claim 18, wherein the request includes a supplemental personal authentication key, the method further comprising determining that the proxy identification key is associated with the supplemental personal authentication key.

28. The method of claim 18, wherein the permanent identification information of the user is the social security number of the user.

29. A method comprising:
generating a first proxy identification key for a user, the first proxy identification key being a substitute for the permanent identification information of the user;
storing the first proxy identification key in a profiles database;
receiving a request to determine whether the first proxy identification key is associated with a second proxy identification key;
generating a response based on a determination of whether the second proxy identification key is associated with the profile of the user.

30. The method of claim 29, the first proxy identification wherein key is associated with a list of proxy identification keys generated by a service provider.

31. A machine-readable medium having instruction data to cause a machine to:
receive a request for personal information of a user, the personal information associated with permanent identification information of the user
determine that the request includes a proxy identification key, the proxy identification key being a substitute for the permanent identification information of the user;
determine that the proxy identification key is associated with the user;
obtain the requested personal information of the user; and
deliver the obtained personal information of the user to an originator of the request.

32. A system comprising:
a communications module to receive a request for personal information of a user;
a detector to:
determine that the request includes a proxy identification key and a permanent identification of the user,
determine one or more restrictions associated with the proxy identification key, and
determine that the one or more restrictions do not preclude the request for personal information of the user;
a matching module to determine that the proxy identification key is associated with the permanent identification of the user;
a data retrieval module to access the permanent identification of the user; and
a delivery module to deliver the permanent identification of the user to an originator of the request.

33. The system of claim 32, wherein the permanent identification of the user is the social security number of the user.

34. The system of claim 32, wherein:
the data retrieval module is to determine a permitted amount of information associated with the proxy identification key; and
the delivery module is to notify to the originator of the request regarding the permitted amount of information.

35. The system of claim 32, wherein the one or more restrictions include a purpose of inquiry restriction.

36. The system of claim 32, wherein the one or more restrictions include a type of information restriction.

37. The system of claim 32, wherein the one or more restrictions include a date of inquiry restriction.

38. The system of claim 32, wherein the one or more restrictions include a number of uses restriction.

39. The system of claim 32, wherein the one or more restrictions include a requester restriction.

40. A system comprising:
a communications module to receive a request for a permanent identification of the user;
a detector to determine that the request includes a proxy identification key, the proxy identification key being a substitute for the permanent identification of the user;
a matching module to determine that the proxy identification key is associated with the user;
a data retrieval module to access the permanent identification of the user; and
a delivery module to deliver the permanent identification of the user to a destination.

41. The system of claim 40, wherein the destination is associated with an originator of the request.

42. The system of claim 40, wherein the destination is associated with an agency that has access to the user's personal data.

43. The system of claim 40, wherein:
the request for the permanent identification of the user includes a request for personal information of the user;
the data retrieval module is to obtain personal information of the user; and
the delivery module is to deliver the obtained personal information of the user to an originator of the request.

44. The system of claim 40, wherein the data retrieval module is to:
determine that the proxy identification key is associated with a specific purpose of inquiry; and
determine that the request is associated with the specific purpose of inquiry.

45. The system of claim 40, wherein the delivery module is to:
determine that the proxy identification key is associated with a specific type of information; and
determine that the request is associated with the specific type of information.

46. The system of claim 40, wherein the delivery module is to:
determine a permitted amount of information associated with the proxy identification key; and
communicate information regarding the permitted amount of information to an originator of the request.

47. The system of claim 40, wherein the data retrieval module is to:
determine that the proxy identification key is restricted to one or more vendors; and
determine that the request is associated with the one or more vendors.

48. The system of claim 40, wherein the delivery module is to:
determine that the proxy identification key is associated with one or more permitted dates; and
determine that the request is made on a permitted date from the one or more permitted dates.

49. The system of claim 40, wherein the data retrieval module is to:
determine that the proxy identification key is restricted to a predetermined number of uses; and
determine that the proxy identification key has been used less than the predetermined number prior to the request.

50. The system of claim 40, wherein the proxy identification key includes nine characters.

51. The system of claim 50, wherein the proxy identification key includes one or more dedicated symbols.

52. The system of claim 40, wherein the proxy identification key is in a format customary for user identification in an environment, in which the proxy identification key is being used.

53. The system of claim 40, wherein the detector is to:
detect a supplemental personal authentication key associated with the request; and
determine that the proxy identification key is associated with the supplemental personal authentication key.

54. The system of claim 40, wherein the permanent identification information of the user is the social security number of the user.

55. The system of claim 40, wherein the permanent identification information of the user is the passport number of the user.

56. The system of claim 40, wherein the permanent identification information of the user is the driver's license number of the user.

57. The system of claim 40, wherein the permanent identification information of the user is the Identification Card number of the user.

58. The system of claim 40, wherein the permanent identification information includes the name of the user.
